(19) United States
(12) Patent Application Publication
(10) Pub. No.: US 2026/0136441 A1
(43) Pub. Date: May 14, 2026

(54) HIGH-COMPATIBILITY MULTIFUNCTIONAL LIGHTING DEVICE

(71) Applicant: Xiamen PVTECH Co., Ltd., Xiamen (CN)

(72) Inventors: CHUNMING LIU, Xiamen (CN); FUXING LU, Xiamen (CN)

(21) Appl. No.: 19/370,620

(22) Filed: Oct. 27, 2025

(30) Foreign Application Priority Data
Nov. 8, 2024 (CN) 202411595406.9

(51) Int. Cl. H05B 45/345; H05B 45/10; H05B 45/37; H05B 45/50; H05B 47/17; H05B 47/24

(52) U.S. Cl. CPC H05B 45/345; H05B 45/10; H05B 45/37; H05B 45/50; H05B 47/17; H05B 47/24

(57) ABSTRACT

A high-compatibility multifunctional lighting device includes a first rectification module, a signal isolation module, an electromagnetic compatibility module, a rear-stage constant current module, a second rectification module and a load. The first rectification module is connected to the first live wire input terminal and the first neutral wire input terminal of an external power supply. The signal isolation module is connected to the first rectification module. The electromagnetic compatibility module is connected to the signal isolation module. The rear-stage constant current module is connected to the electromagnetic compatibility module. The second rectification module is connected to the second live wire input terminal and the second neutral wire input terminal of the external power supply. The second rectification module is connected to the rear-stage constant current module, and connected in parallel with the first rectification module. The load is connected to the rear-stage constant current module.

### TECHNICAL FIELD

The disclosure relates to a lighting device, in particular to a high-compatibility

multifunctional lighting device.

### BACKGROUND

Fluorescent tubes are a common type of lighting device. However, certain applications require lighting devices with dimming functions and emergency functions, which necessitate complex ballast circuit designs. Accordingly, light-emitting diode (LED) tubes capable of replacing fluorescent tubes have been developed to address the above issues.

Nevertheless, currently available LED tubes still have many drawbacks that require further improvement. For example, the currently available LED tubes lack appropriate dimming circuit designs, and therefore still fail to achieve satisfactory dimming performance.

In addition, the currently available LED tubes also lack proper electric shock protection mechanisms, and thus their safety remains to be improved.

Therefore, the currently available LED tubes are still unable to meet actual requirements.

### SUMMARY

One embodiment of the disclosure provides a high-compatibility multifunctional lighting device includes a first rectification module, a signal isolation module, an electromagnetic compatibility module, a rear-stage constant current module and a second rectification module. The first rectification module is connected to the first live wire input terminal and the first neutral wire input terminal of an external power supply. The signal isolation module is connected to the first rectification module. The electromagnetic compatibility module is connected to the signal isolation module. The rear-stage constant current module is connected to the electromagnetic compatibility module. The second rectification module is connected to the second live wire input terminal and the second neutral wire input terminal of the external power supply. The second rectification module is connected to the rear-stage constant current module, and connected in parallel with the first rectification module. The load is connected to the rear-stage constant current module.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given

herein below and the accompanying drawings which are given by way of illustration only, and thus are not limitative of the disclosure and wherein:

FIG. 1 is a block diagram of a circuit structure of a high-compatibility multifunctional lighting device in accordance with a first embodiment of the disclosure.

FIG. 2 is a block diagram of a circuit structure of a high-compatibility multifunctional lighting device in accordance with a second embodiment of the disclosure.

FIG. 3 is a circuit diagram of a high-compatibility multifunctional lighting device in accordance with a third embodiment of the disclosure.

### DETAILED DESCRIPTION

In the following detailed description, for purposes of explanation, numerous specific

details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

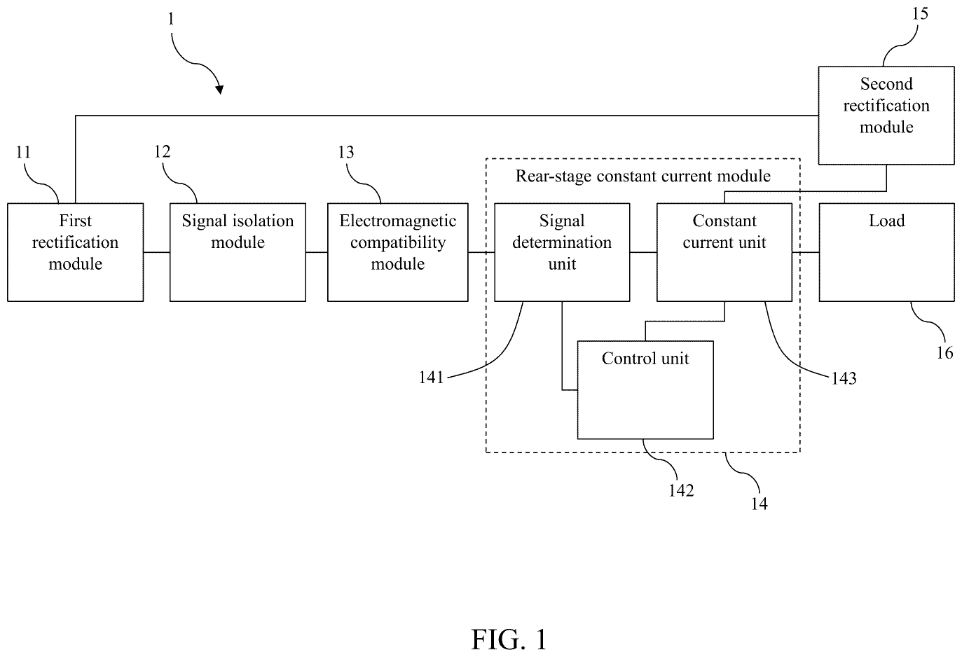

Please refer to FIG. 1, which is a block diagram of a circuit structure of a high-compatibility multifunctional lighting device in accordance with a first embodiment of the disclosure. As shown in FIG. 1, the lighting device 1 includes a first rectification module 11, a signal isolation module 12, an electromagnetic compatibility module 13, a rear-stage constant current module 14, a second rectification module 15, and a load 16.

The first rectification module 11 is connected to the first live wire input terminal Lt1 and the first neutral wire input terminal Nt1 of an external power supply. The external power supply may be a lamp holder connected to a utility power. In one embodiment, the first rectification module 11 may be a rectifier bridge. In another embodiment, the first rectification module 11 may also be various full-wave rectifiers or half-wave rectifiers.

The signal isolation module 12 is connected to the first rectification module 11. In one embodiment, the signal isolation module 12 may be a diode. In another embodiment, the signal isolation module 12 may also be various components having signal isolation functions.

The electromagnetic compatibility module 13 is connected to the signal isolation module 12. In one embodiment, the electromagnetic compatibility module 13 may be a Type II filter. In another embodiment, the electromagnetic compatibility module 13 may also be other circuits having electromagnetic compatibility functions. The electromagnetic compatibility module 13 can prevent the operating frequency from exceeding a preset upper limit value, so that the lighting device 1 complies with safety standards.

The rear-stage constant current module 14 is connected to the electromagnetic compatibility module 13. The rear-stage constant current module 14 includes a signal determination unit 141, a control unit 142, and a constant current unit 143. The signal determination unit 141 is connected to the electromagnetic compatibility module 13, the control unit 142, and the constant current unit 143. The control unit 142 is connected to the signal determination unit 141 and the constant current unit 143. In one embodiment, the signal determination unit 141 may be a circuit including a plurality of resistors. The constant current unit 143 may provide a constant current function. In one embodiment, the control unit 142 may be a microcontroller (MCU). In another embodiment, the control unit 142 may be a central-processing unit (CPU), an application-specific integrated circuit (ASIC), a field-programmable gate array (FPGA), or other similar components. The control unit 142 has a special dimming control mechanism, which can effectively be compatible with both leading-edge dimming and trailing-edge dimming without changing the original dimmer. Therefore, the lighting device 1 can meet the requirements of different applications. In addition, the control unit 142 has a special memory function, which can store a current operating mode as a target operating mode when detecting that the number of switching operations within a preset time exceeds a preset value. Then, the control unit 142 can directly operate in the target operating mode when entering the on state the next time. The above memory function can greatly improve the operating efficiency of the lighting device 1.

The second rectification module 15 is connected to a second live wire input terminal Lt2 and a second neutral wire input terminal Nt2 of the external power supply, connected to the rear-stage constant current module 14 (the constant current unit 143), and connected in parallel with the first rectification module 11. In one embodiment, the second rectification module 15 may be a rectifier bridge. In another embodiment, the second rectification module 15 may also be various full-wave rectifiers or half-wave rectifiers.

The load 16 is connected to the rear-stage constant current module 14 (the constant current unit 143). In one embodiment, the load 16 may be a plurality of light-emitting diodes LD connected in series. In one embodiment, the load 16 may also be a plurality of light-emitting diodes LD based on series circuits and/or parallel circuits.

As described above, in this embodiment, the lighting device 1 includes the first rectification module 11, the signal isolation module 12, the electromagnetic compatibility module 13, the rear-stage constant current module 14, the second rectification module 15, and the load 16. The first rectification module 11 is connected to the first live wire input terminal Lt1 and the first neutral wire input terminal Nt1 of the external power supply. The signal isolation module 12 is connected to the first rectification module 11. The electromagnetic compatibility module 13 is connected to the signal isolation module 12. The rear-stage constant current module 14 is connected to the electromagnetic compatibility module 13. The second rectification module 15 is connected to the second live wire input terminal Lt2 and the second neutral wire input terminal Nt2 of the external power supply, connected to the rear-stage constant current module 14, and connected in parallel with the first rectification module 11. The load 16 is connected to the rear-stage constant current module 14. The circuit structure of the lighting device 1 integrates the signal isolation module 12, which can effectively prevent interference signals generated by the electromagnetic compatibility module 13, so that the signal determination unit 141 of the rear-stage constant current module 14 can effectively detect the status of the input signal. Therefore, the performance of the lighting device 1 can be greatly optimized.

The embodiment just exemplifies the disclosure and is not intended to limit the scope of the disclosure; any equivalent modification and variation according to the spirit of the disclosure is to be also included within the scope of the following claims and their equivalents.

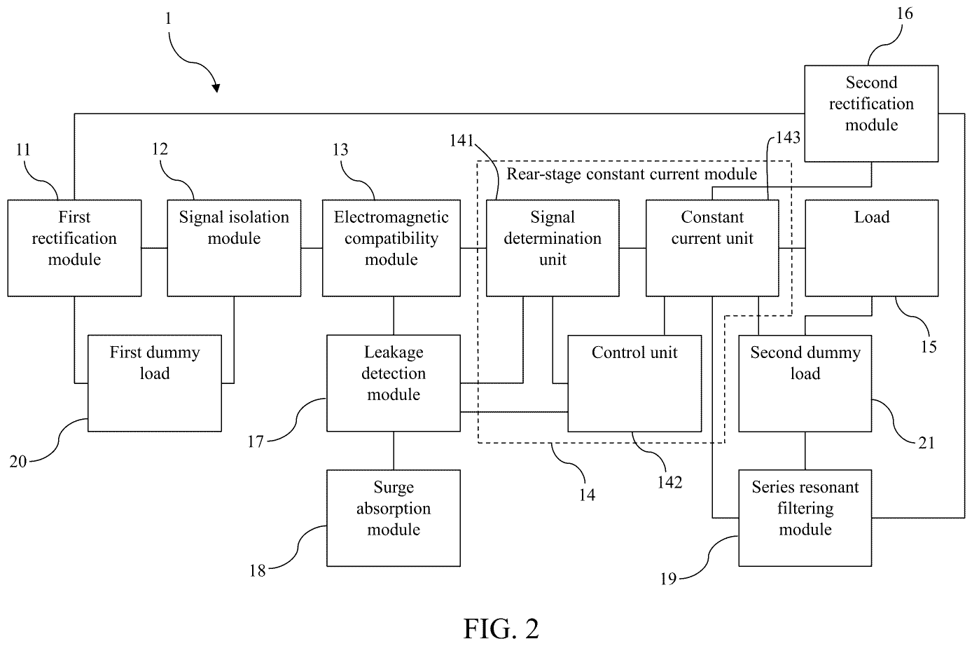

Please refer to FIG. 2, which is a block diagram of a circuit structure of a high-compatibility multifunctional lighting device in accordance with a second embodiment of the disclosure. As shown in FIG. 2, the lighting device 1 includes a first rectification module 11, a signal isolation module 12, an electromagnetic compatibility module 13, a rear-stage constant current module 14, a second rectification module 15, and a load 16. The rear-stage constant current module 14 includes a signal determination unit 141, a control unit 142, and a constant current unit 143.

The elements described above are similar to those in the previous embodiment and will not be further elaborated here. The difference between this embodiment and the previous embodiment is that the lighting device 1 of this embodiment further includes a leakage detection module 17, a surge absorption module 18, a series resonant filtering module 19, a first dummy load 20, and a second dummy load 21.

The leakage detection module 17 is disposed between the electromagnetic compatibility module 13 and the rear-stage constant current module 14, and is connected to the electromagnetic compatibility module 13 and the rear-stage constant current module 14 (the signal determination unit 141 and the control unit 142). In one embodiment, the leakage detection module 17 may be a circuit including a plurality of resistors.

The surge absorption module 18 is connected to the leakage detection module 17. In one embodiment, the surge absorption module 18 may be a transient voltage suppression diode TVS. In another embodiment, the surge absorption module 18 may also be various circuits having surge absorption functions.

The first dummy load 20 is disposed between the signal isolation module 12 and the first rectification module 11, and is connected to the signal isolation module 12 and the first rectification module 11. In one embodiment, the first dummy load 20 may be a resistor. In one embodiment, the first dummy load 20 may also be a series circuit including a plurality of resistors. The first dummy load 20 is the dummy load of the leakage detection module 17. It adopts a separate design (not directly connected to the leakage detection module 17), which can more effectively improve the performance of the leakage detection module 17.

The second dummy load 21 is disposed between the rear-stage constant current module 14 and the load 16, and is connected to the rear-stage constant current module 14 (the constant current unit 143) and the load 16. In one embodiment, the second dummy load 21 may be a resistor. In one embodiment, the second dummy load 21 may also be a series circuit including a plurality of resistors.

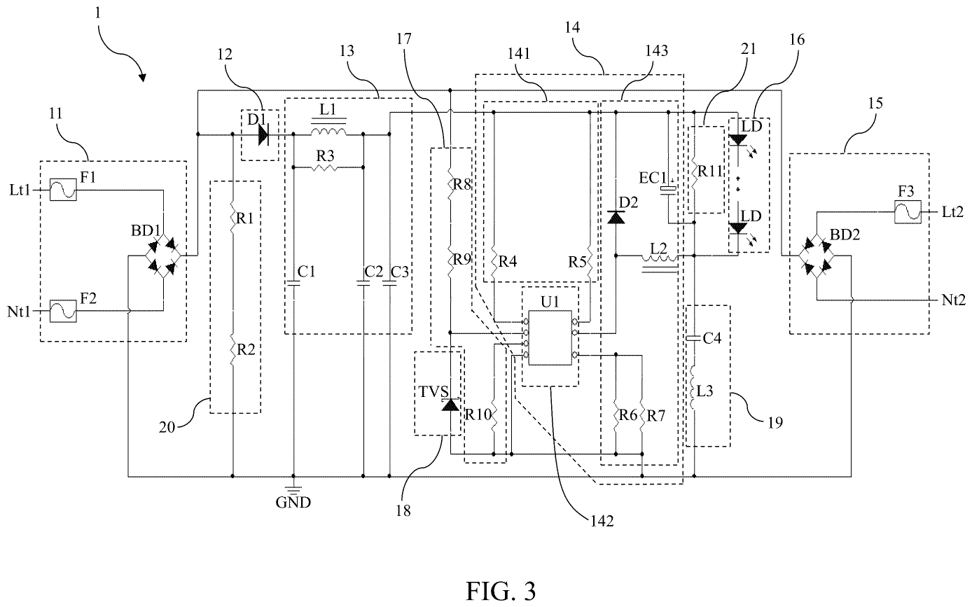

The series resonant filtering module 19 is disposed between the second dummy load 21, the rear-stage constant current module 14, and the common point of the first rectification module 11 and the second rectification module 15 (that is, the grounding point GND of FIG. 3), and is connected to the second dummy load 21, the rear-stage constant current module 14 (the constant current unit 143), the first rectification module 11, and the second rectification module 15. In one embodiment, the series resonant filtering module 19 may be a circuit including an inductor. In one embodiment, the series resonant filtering module 19 may also be a circuit including a capacitor, or a circuit including both an inductor and a capacitor.

Similarly, in this embodiment, the circuit structure of the lighting device 1 integrates the signal isolation module 12, which can effectively prevent interference signals generated by the electromagnetic compatibility module 13, so that the signal determination unit 141 of the rear-stage constant current module 14 can effectively detect the status of the input signal. Therefore, the performance of the lighting device 1 can be greatly optimized.

In addition, in this embodiment, the lighting device 1 further includes the leakage detection module 17. The leakage detection module 17 can trigger an electric shock protection mechanism. By integrating the circuit design of the leakage detection module 17 and the signal isolation module 12, the lighting device 1 can effectively realize both leakage detection and signal isolation functions. Therefore, the performance of the lighting device 1 can be further optimized to meet actual requirements.

The embodiment just exemplifies the disclosure and is not intended to limit the scope of the disclosure; any equivalent modification and variation according to the spirit of the disclosure is to be also included within the scope of the following claims and their equivalents.

It is worthy to point out that currently available LED tubes still have many drawbacks that require further improvement. For example, the currently available LED tubes lack appropriate dimming circuit designs, and therefore still fail to achieve satisfactory dimming performance. In addition, the currently available LED tubes also lack proper electric shock protection mechanisms, and thus their safety remains to be improved. Therefore, the currently available LED tubes are still unable to meet actual requirements. By contrast, according to one embodiment of the present invention, the lighting device 1 includes a first rectification module 11, a signal isolation module 12, an electromagnetic compatibility module 13, a rear-stage constant current module 14, a second rectification module 15 and a load 16. The first rectification module 11 is connected to the first live wire input terminal Lt1 and the first neutral wire input terminal Nt1 of an external power supply. The signal isolation module 12 is connected to the first rectification module 11. The electromagnetic compatibility module 13 is connected to the signal isolation module 12. The rear-stage constant current module 14 is connected to the electromagnetic compatibility module 13. The second rectification module 15 is connected to the second live wire input terminal Lt2 and the second neutral wire input terminal Nt2 of the external power supply. The second rectification module 15 is connected to the rear-stage constant current module 14, and connected in parallel with the first rectification module 11. The load 16 is connected to the rear-stage constant current module 14. Accordingly, the circuit structure of the lighting device 1 integrates the signal isolation module 12, which can effectively prevent interference signals generated by the electromagnetic compatibility module 13, so that the signal determination unit 141 of the rear-stage constant current module 14 can effectively detect the status of an input signal. Therefore, the performance of the lighting device 1 can be significantly optimized.

Also, according to one embodiment of the present invention, the lighting device 1 further includes a leakage detection module 17. The leakage detection module 17 is disposed between the electromagnetic compatibility module 13 and the rear-stage constant current module 14, and is connected to the electromagnetic compatibility module 13 and the rear-stage constant current module 14. The leakage detection module 17 can trigger an electric shock protection mechanism. By integrating the circuit design of the leakage detection module 17 and the signal isolation module 12, the lighting device 1 can effectively achieve both leakage detection and signal isolation functions. Therefore, the performance of the lighting device 1 can be further optimized to meet actual requirements.

Further, according to one embodiment of the present invention, the control unit 142 of the rear-stage constant current module 14 of the lighting device 1 has a special dimming control mechanism, which can effectively be compatible with both leading-edge dimming and trailing-edge dimming without the need to change the original dimmer. Therefore, the lighting device 1 can meet the requirements of different applications.

Moreover, according to one embodiment of the present invention, the control unit 142 of the rear-stage constant current module 14 of the lighting device 1 has a special memory function, which can store a current operating mode as a target operating mode when the number of switching operations detected within a preset time exceeds a preset value. Then, the control unit 142 can directly operate in the target operating mode when entering the on state the next time. The above memory function can greatly improve the operating efficiency of the lighting device 1.

Furthermore, according to one embodiment of the present invention, the lighting device 1 includes the electromagnetic compatibility module 13. The electromagnetic compatibility module 13 can prevent the operating frequency from exceeding a preset upper limit value, so that the lighting device 1 can comply with safety standards. Therefore, the lighting device 1 can be more comprehensive in application and more flexible in use. As set forth above, the lighting device 1 according to the embodiments of the disclose can definitely achieve great technical effects.

Please refer to FIG. 3, which is a circuit diagram of a high-compatibility multifunctional lighting device in accordance with a third embodiment of the disclosure. This embodiment illustrates one of the circuit structures of the lighting device 1. As shown in FIG. 3, the lighting device 1 includes a first rectification module 11, a signal isolation module 12, an electromagnetic compatibility module 13, a rear-stage constant current module 14, a second rectification module 15, a load 16, a leakage detection module 17, a surge absorption module 18, a series resonant filtering module 19, a first dummy load 20, and a second dummy load 21 (GND represents the grounding point). The connection relationships of the above modules are the same as those in FIG. 2 and will not be repeated here.

The first rectification module 11 includes a first rectifier BD1, a first fuse F1, and a second fuse F2. The first rectifier BD1 is connected to the first live wire input terminal Lt1 and the first neutral wire input terminal Nt1 through the first fuse F1 and the second fuse F2, respectively.

The signal isolation module 12 includes a first diode D1.

The electromagnetic compatibility module 13 includes a first inductor L1, a third resistor R3, a first capacitor C1, a second capacitor C2, and a third capacitor C3.

The rear-stage constant current module 14 includes a signal determination unit 141, a control unit 142, and a constant current unit 143. The signal determination unit 141 includes a fourth resistor R4 and a fifth resistor R5. The control unit 142 includes a controller U1. The constant current unit 143 includes an electrolytic capacitor EC1, a second diode D2, a second inductor L2, a sixth resistor R6, and a seventh resistor R7.

The second rectification module 15 includes a second rectifier BD2 and a third fuse F3. The second rectifier BD2 is connected to the second live wire input terminal Lt2 of the external power supply through the third fuse F3, and directly connected to the second neutral wire input terminal Nt2 of the external power supply.

The load 16 includes a plurality of light-emitting diodes LD connected in series.

The leakage detection module 17 includes an eighth resistor R8, a ninth resistor R9, and a tenth resistor R10.

The surge absorption module 18 includes a transient voltage suppression diode TVS.

The series resonant filtering module 19 includes a fourth capacitor C4 and a third inductor L3.

The first dummy load 20 includes a first resistor R1 and a second resistor R2.

The second dummy load 21 includes an eleventh resistor R11.

The first rectification module 11 includes the first rectifier BD1, the first fuse F1, and the second fuse F2. The first rectifier BD1 is connected to the first live wire input terminal Lt1 and the first neutral wire input terminal Nt1 through the first fuse F1 and the second fuse F2, respectively. The second rectification module 15 includes the second rectifier BD2 and the third fuse F3. The second rectifier BD2 is connected to the second live wire input terminal Lt2 of the external power supply through the third fuse F3, and directly connected to the second neutral wire input terminal Nt2 of the external power supply. The second rectification module 15 is further connected to the rear-stage constant current module 14 (the constant current unit 143) and connected in parallel with the first rectification module 11. The above three fuses ensure that at least one fuse is inserted into the circuit to guarantee circuit safety. The fuses provide an effective overcurrent protection function, thereby greatly improving the safety of the lighting device 1.

The AC input current is rectified by the first rectifier BD1 and the second rectifier BD2 to form a DC current, which then passes through the eighth resistor R8 and the ninth resistor R9 to enter the controller U1. The controller U1 performs zero-crossing verification to determine whether the AC input current is inputted from the utility power. If not, the controller turns off the rear-stage constant current module 14. At the same time, the controller U1 monitors the voltage of the tenth resistor R10. For example, when the resistance ratio between the tenth resistor R10 and human body impedance is 1:10 (the ratio may be adjusted according to actual requirements), if the voltage of the tenth resistor R10 increases more than ten times, the controller U1 determines a possible leakage risk. Therefore, the controller U1 turns off the rear-stage constant current module 14 to prevent electric shock.

The signal isolation module 12 allows the rectified DC current to pass in a single direction. Various currents or voltages generated by the rear-stage circuit cannot flow back through the signal isolation module 12. The signal isolation module 12 can effectively prevent interference signals generated by the electromagnetic compatibility module 13, so that the signal determination unit 141 of the rear-stage constant current module 14 can effectively detect the state of the input signal. Therefore, the performance of the lighting device 1 can be greatly optimized. As a result, the controller U1 can precisely perform leakage detection functions through the leakage detection module 17 and execute various necessary operations.

The electromagnetic compatibility module 13 can prevent the operating frequency from exceeding a preset upper limit value, enabling the lighting device 1 to comply with safety regulations. Therefore, the lighting device 1 can be comprehensive in application and more flexible in use.

When the controller U1 cannot detect a complete sinusoidal half-wave voltage through the eighth resistor R8 and the ninth resistor R9, the controller U1 compares the voltage V4 detected by the fourth resistor R4 with the voltage V5 detected by the fifth resistor R5. If the voltage V5 is greater than the voltage V4, the controller U1 determines that a leading-edge dimmer is connected, and switches to the leading-edge operating mode. If the voltage V5 is less than the voltage V4, the controller U1 determines that a trailing-edge dimmer is connected, and switches to the trailing-edge operating mode. If the voltage V5 equals the voltage V4, the controller U1 determines that a DC voltage source is connected, and switches to the DC operating mode.

The controller U1 further performs a memory function. It stores the current operating mode as a target operating mode when detecting that the number of switching operations within a preset time (such as 8 seconds, 10 seconds, 15 seconds, etc.) exceeds a preset value (5 times, 6 times, 7 times, etc.). Then, when the controller U1 next enters the on state, it directly operates in the target operating mode. The above memory function can greatly enhance the operating efficiency of the lighting device 1.

From the above, it is known that in this embodiment, the circuit structure of the lighting device 1 integrates the signal isolation module 12, which can effectively prevent interference signals generated by the electromagnetic compatibility module 13, so that the signal determination unit 141 of the rear-stage constant current module 14 can effectively detect the state of the input signal. Therefore, the performance of the lighting device 1 can be greatly optimized.

In addition, in this embodiment, the lighting device 1 includes the leakage detection module 17. The leakage detection module 17 can trigger an anti-electric-shock mechanism. By integrating the circuit design of the leakage detection module 17 and the signal isolation module 12, the lighting device 1 can effectively realize leakage detection and signal isolation functions. Therefore, the performance of the lighting device 1 can be further optimized to meet actual requirements.

Furthermore, in this embodiment, the control unit 142 of the rear-stage constant current module 14 of the lighting device 1 has a special dimming control mechanism, which can effectively support both leading-edge dimming and trailing-edge dimming without changing the original dimmer. Therefore, the lighting device 1 can meet the requirements of different application.

Moreover, in this embodiment, the control unit 142 of the rear-stage constant current module 14 of the lighting device 1 has a special memory function. It can store the current operating mode as the target operating mode when detecting that the number of switching operations within a preset time exceeds a preset value. Then, when the control unit 142 next enters the on state, it directly operates in the target operating mode. The above memory function can greatly improve the operating efficiency of the lighting device 1.

The embodiment just exemplifies the disclosure and is not intended to limit the scope of the disclosure; any equivalent modification and variation according to the spirit of the disclosure is to be also included within the scope of the following claims and their equivalents.

To sum up, according to one embodiment of the present invention, the lighting device 1 includes a first rectification module 11, a signal isolation module 12, an electromagnetic compatibility module 13, a rear-stage constant current module 14, a second rectification module 15 and a load 16. The first rectification module 11 is connected to the first live wire input terminal Lt1 and the first neutral wire input terminal Nt1 of an external power supply. The signal isolation module 12 is connected to the first rectification module 11. The electromagnetic compatibility module 13 is connected to the signal isolation module 12. The rear-stage constant current module 14 is connected to the electromagnetic compatibility module 13. The second rectification module 15 is connected to the second live wire input terminal Lt2 and the second neutral wire input terminal Nt2 of the external power supply. The second rectification module 15 is connected to the rear-stage constant current module 14, and connected in parallel with the first rectification module 11. The load 16 is connected to the rear-stage constant current module 14. Accordingly, the circuit structure of the lighting device 1 integrates the signal isolation module 12, which can effectively prevent interference signals generated by the electromagnetic compatibility module 13, so that the signal determination unit 141 of the rear-stage constant current module 14 can effectively detect the status of an input signal. Therefore, the performance of the lighting device 1 can be significantly optimized.

According to one embodiment of the present invention, the lighting device 1 further includes a leakage detection module 17. The leakage detection module 17 is disposed between the electromagnetic compatibility module 13 and the rear-stage constant current module 14, and is connected to the electromagnetic compatibility module 13 and the rear-stage constant current module 14. The leakage detection module 17 can trigger an electric shock protection mechanism. By integrating the circuit design of the leakage detection module 17 and the signal isolation module 12, the lighting device 1 can effectively achieve both leakage detection and signal isolation functions. Therefore, the performance of the lighting device 1 can be further optimized to meet actual requirements.

Also, according to one embodiment of the present invention, the control unit 142 of the rear-stage constant current module 14 of the lighting device 1 has a special dimming control mechanism, which can effectively be compatible with both leading-edge dimming and trailing-edge dimming without the need to change the original dimmer. Therefore, the lighting device 1 can meet the requirements of different applications.

Further, according to one embodiment of the present invention, the control unit 142 of the rear-stage constant current module 14 of the lighting device 1 has a special memory function, which can store a current operating mode as a target operating mode when the number of switching operations detected within a preset time exceeds a preset value. Then, the control unit 142 can directly operate in the target operating mode when entering the on state the next time. The above memory function can greatly improve the operating efficiency of the lighting device 1.

Moreover, according to one embodiment of the present invention, the lighting device 1 includes the electromagnetic compatibility module 13. The electromagnetic compatibility module 13 can prevent the operating frequency from exceeding a preset upper limit value, so that the lighting device 1 can comply with safety standards. Therefore, the lighting device 1 can be more comprehensive in application and more flexible in use.

Furthermore, according to one embodiment of the present invention, the first rectification module 11 of the lighting device 1 includes a first rectifier BD1, a first fuse F1, and a second fuse F2. The first rectifier BD1 is connected to the first live wire input terminal Lt1 and the first neutral wire input terminal Nt1 through the first fuse F1 and the second fuse F2, respectively. The second rectification module 15 of the lighting device 1 includes a second rectifier BD2 and a third fuse F3. The second rectifier BD2 is connected to the second live wire input terminal Nt2 through the third fuse F3. The fuses described above can provide effective overcurrent protection, which can greatly enhance the safety of the lighting device 1.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is

1. A high-compatibility multifunctional lighting device, comprising:
a first rectification module connected to a first live wire input terminal and a first neutral wire input terminal of an external power supply;
a signal isolation module connected to the first rectification module;
an electromagnetic compatibility module connected to the signal isolation module;
a rear-stage constant current module connected to the electromagnetic compatibility module;
a second rectification module connected to a second live wire input terminal and a second neutral wire input terminal of the external power supply, wherein the second rectification module is connected to the rear-stage constant current module, and connected in parallel with the first rectification module; and
a load connected to the rear-stage constant current module.

2. The high-compatibility multifunctional lighting device as claimed in claim 1, wherein the signal isolation circuit is a diode.

3. The high-compatibility multifunctional lighting device as claimed in claim 1, further comprising a leakage detection module disposed between the electromagnetic compatibility module and the rear-stage constant current module, and connected to the electromagnetic compatibility module and the rear-stage constant current module.

4. The high-compatibility multifunctional lighting device as claimed in claim 3, further comprising a surge absorption module connected to the leakage detection module.

5. The high-compatibility multifunctional lighting device as claimed in claim 4, wherein the surge absorption module is a transient voltage suppression diode.

6. The high-compatibility multifunctional lighting device as claimed in claim 3, wherein the leakage detection module further comprises a first dummy load disposed between the signal isolation module and the first rectification module, and connected to the signal isolation module and the first rectification module.

7. The high-compatibility multifunctional lighting device as claimed in claim 1, wherein the rear-stage constant current module further comprises a second dummy load disposed between the rear-stage constant current module and the load, and connected to the rear-stage constant current module and the load.

8. The high-compatibility multifunctional lighting device as claimed in claim 7, further comprising a series resonant filtering module disposed between the second dummy load, the rear-stage constant current module, and a common point of the first rectification module and the second rectification module, and connected to the second dummy load, the rear-stage constant current module, the first rectification module, and the second rectification module.

9. The high-compatibility multifunctional lighting device as claimed in claim 1, wherein the first rectification module comprises a first rectifier, a first fuse, and a second fuse, and the first rectifier is connected to the first live wire input terminal and the first neutral wire input terminal through the first fuse and the second fuse respectively.

10. The high-compatibility multifunctional lighting device as claimed in claim 1, wherein the second rectification module comprises a second rectifier and a third fuse, and the second rectifier is connected to the second live wire input terminal through the third fuse.
